(19) United States
(12) Patent Application Publication
(10) Pub. No.: US 2012/0195540 A1
(43) Pub. Date: Aug. 2, 2012

(54) Roller bearing backing ring assembly

(75) Inventors: Paul A. Hubbard, Petersburg, VA (US); Michael Mason, Richmond, VA (US)

(73) Assignee: Amsted Rail Company, Inc., Chicago, IL (US)

(21) Appl. No.: 12/931,249

(22) Filed: Jan. 28, 2011

(51) Int. Cl. F16C 33/48

(52) U.S. Cl. 384/572

(57) ABSTRACT

A novel assembly for a railcar axle bearing is presented. The assembly includes a backing ring affixed to the fillet of the journal of an axle and a locking ring for further affixing the backing ring the journal. The locking ring has an inboard end affixed to the dust guard of the axle and an outboard end for engaging the backing ring.

### FIELD OF THE INVENTION

This invention relates to roller bearings, and more particularly, to tapered roller bearings fitted on railway freight car axles.

### BACKGROUND OF THE INVENTION

Tapered roller bearings on railcar axles support operating loads capable of producing significant flexural deflections in the axle, and in particular, the end portion of the axle comprising the journal on which the tapered roller bearing is affixed. The stresses imposed by the operating loads are particularly high in the journal portion of the shaft at or near the backing ring.

As result of shaft deflections, the backing ring and the journal often experience fretting wear as the backing ring moves relative to the journal. Fretting wear may be sufficient to loosen the backing ring, increasing the axial play of the bearing on the journal. The loose backing ring accelerates wear on the bearing assembly and journal, potentially leading to shaft or bearing failure.

The backing ring design is a single piece component having an angled section engaging the dust guard portion of the axle.

### SUMMARY OF THE INVENTION

To reduce the potential for fretting wear on journals and backing rings, an assembly is presented having increased stability to reduce fretting wear. The assembly is composed of two components: (1) a backing ring fitted on the journal and (2) a locking ring to connect with and further affix the backing ring on the journal. The locking ring has an lateral outer end engaging the backing ring and an lateral inner end adjacent to the outer diameter of the dust guard portion of the axle. The locking ring reduces axial movement in the backing ring resulting from axle deflection.

### BRIEF DESCRIPTION OF THE FIGURES

In the drawings,

FIG. 1 is a sectional view of a first embodiment of the backing ring assembly of the present invention;

FIG. 2 is an enlarged sectional view of the first embodiment of the backing ring assembly of the present invention;

FIG. 3 is an enlarged sectional view of a second embodiment of the backing ring assembly of the present invention;

FIG. 4 is an enlarged sectional view of the third embodiment of the backing ring assembly of the present invention;

FIG. 5 is an enlarged sectional view of a fourth embodiment of the backing ring assembly of the present invention;

FIG. 6 is an enlarged sectional view of a fifth embodiment of the backing ring assembly of the present invention;

FIG. 7 is an enlarged sectional view of a sixth embodiment of the backing ring assembly of the present invention;

FIG. 8 is an enlarged sectional view of a seventh embodiment of the backing ring assembly of the present invention;

FIG. 9 is an enlarged sectional view of an eighth embodiment of the backing ring assembly of the present invention.

### DETAILED DESCRIPTION

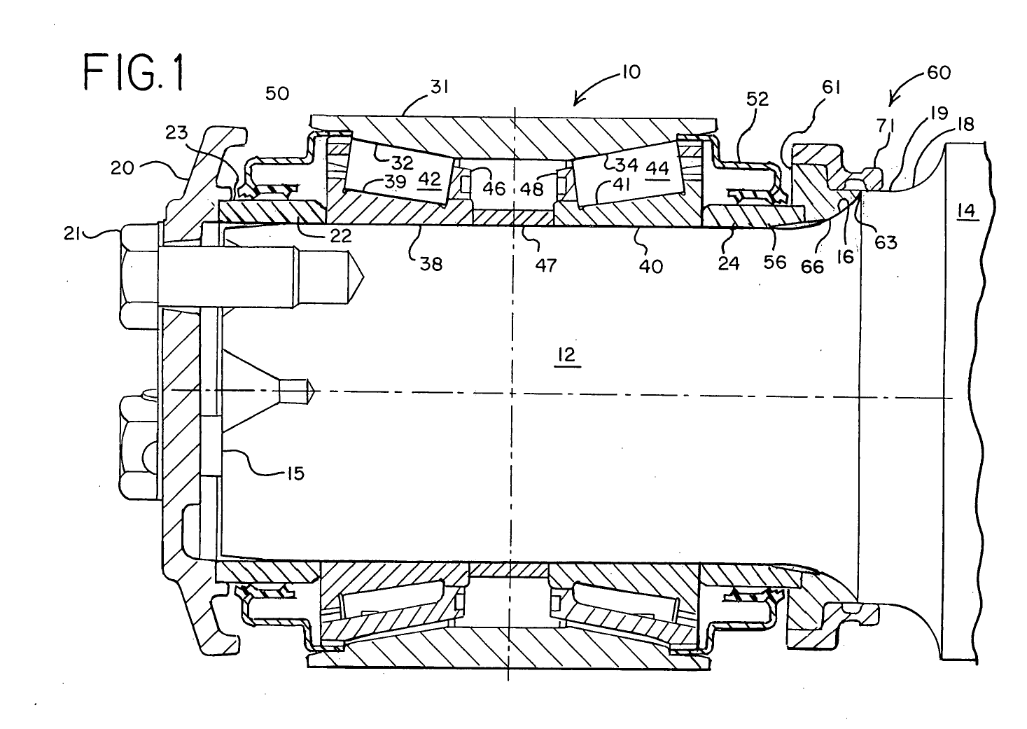

Referring to FIG. 1, one embodiment of the backing ring assembly is illustrated. In this embodiment, the bearing assembly 10 is a tapered roller bearing of the type commonly used in railway applications to support a railcar wheel on an axle.

The bearing assembly 10 is typically preassembled before being mounted on railcar axle 14. At each free end of the axle 14, a journal 12 terminates in a slightly conical tapered section 15 to facilitate installation of the bearing assembly 10 onto the journal. The bearing assembly 10 is pressed onto the journal 12 of the axle 14 to establish an interference fit.

A dust guard 18 with a larger diameter than the journal 12 is located axially inward from the journal 12. Axially inward from the dust guard 18, the shaft 14 extends to its largest diameter. The weight of the railcar is transferred through the bearing assembly 10 to the shaft and further transferred to the rails through the railcar wheels (not shown) fitted inboard of the dust guard on the shaft.

Some bearing assemblies 10 have wear rings 22, 24 fitted over the journal 12 and which abut each end of the bearing assembly 10. The wear rings 22, 24 typically have an inner diameter dimension to provide an interference fit with the journal 12 over at least a portion of their length. The wear rings 22, 24 rotate with the shaft as it turns.

Although the bearing assembly 10 is pressed onto the journal 12, further restraint is generally required against axial loads. To provide this axial restraint, the bearing assembly 10 is captured between a backing ring assembly 60 at the inboard side and a bearing retaining cap 20 at the outboard side of the bearing assembly 10.

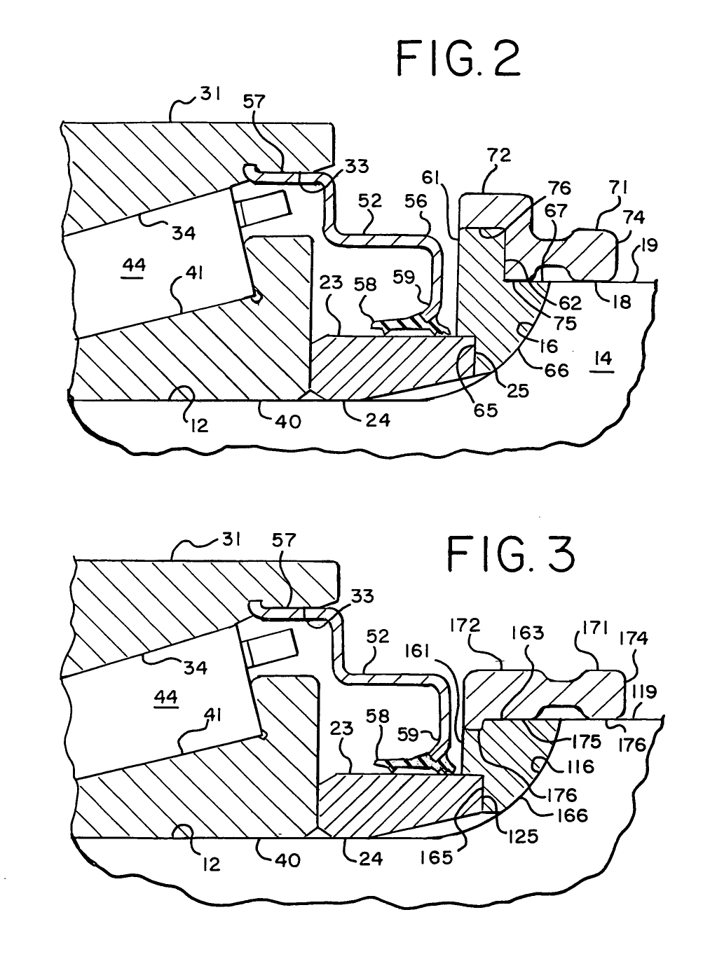

Referring now to FIG. 2 as well, at the inboard side of the journal 12 portion of axle 14, the bearing assembly 10 is captured by the backing ring 61 through abutting wear ring 24. Backing ring 61 has an inner contoured surface 66 allowing a tight surface fit with a complementary surface on the fillet 16 on the inboard end of the journal 12. The fillet 16 leads to a shoulder 17, the shoulder extending to form a dust guard 18 having a cylindrical surface 19. Backing ring 61 has an inboard distal edge 63 at the contoured surface 66, generally abutting fillet 16.

Locking ring 71, has a lateral inner end adjacent to the dust guard 18. Locking ring lateral outer end engages backing ring 61 and restrains backing ring 61, against deflection and axial displacement. Backing ring 61 and locking ring 71 together form the backing ring assembly 60. Locking ring 71, the furthest inboard component affixed to the journal 12, affixes the bearing assembly 10 against axially inward displacement.

At the outboard end of the journal, the bearing assembly 10 is captured by the bearing retaining cap 20 through the interposed and abutting outboard wear ring 22. Bearing retaining cap 20 is affixed to the free end of journal 12 with cap screws or bolts 21 threaded into a plurality of threaded bores. Bearing retaining cap 20 completes the mounting of the bearing assembly 10 onto the journal 12, providing a clamping force to restrain the bearing assembly against axially outward displacement.

The bearing assembly 10 is preassembled from a number of individual components, including two cylindrical bearing cones 38, 40 and a cylindrical bearing cup 31. Bearing cup 31 has an inner surface having radially inward directed outer raceways 32, 34. The bearing cones 38, 40 have radially outward directed inner raceways 39, 41. A center spacer 47 is positioned between the bearing cones 38, 40 to maintain the cones in accurately spaced position relative to each other and allow for proper bearing lateral clearance. The outer raceways 32, 34 in the bearing cup 31 cooperate with the inner raceways 39, 41 in the bearing cones 38, 40 to capture and support two rows of the tapered rollers 42, 44. In some embodiments, cages 46, 48 maintain the circumferential spatial positioning of the rollers 42, 44.

Bearing seals 50, 52 cover the ends of the bearing assembly 10 to minimize both lubricant leakage from the bearing and intrusion of contaminants into the bearing. In a first embodiment, the bearing seals 50, 52 are affixed to the stationary (i.e., non-rotating) side of the bearing assembly 10 (such as the bearing cup 31) by interference fit or other appropriate method.

A seal body 56 (typically of a generally cylindrical elastomeric construction) is part of bearing seal 50, 52 to form a dynamic seal between stationary and moving bearing assembly components. In one embodiment, the seal body 56 is urged against the wear ring 22, 24 to seal the bearing assembly 10. A first radial edge 57 of seal body 56 is received against an inner radial surface 33 of bearing cup 31. A second radial edge 59 of seal body 56 extends radially inward and has a resilient seal 58 attached thereto. Resilient seal 58 contacts outer radial surface 23 of wear ring 24.

Cylindrical wear rings 22, 24 protect the journal 12 against rubbing wear from the seal body by providing a wear surface 23.

Referring to FIG. 2, the backing ring assembly 60 of FIG. 1 is illustrated in an enlarged sectional view. Backing ring 61 has an inner contoured surface 66 adjacent the journal 12 at the complementary surface of the fillet 16.

A slot or cutout section 65 in the axially inward directed surface of backing ring 61 receives the laterally inner end 25 of wear ring 24 in an interference fit.

Locking ring 71 further has a lateral outer end 72 of a larger diameter and having a cutout section 76 for receiving a radially outward extending portion 62 of backing ring 61. Locking ring 71 outer end 72 includes an inner radial surface 75 that is adjacent outer radial surface 67 of backing ring 61. Locking ring 71 inner end 74 includes an inner radial surface 78 that is adjacent outer radial surface 19 of axle 14.

Locking ring 71, with its connection between backing ring 61 and the cylindrical surface 19 of the dust guard 18, reinforces and anchors backing ring 61 against axial displacement and deflection. It is believed that the flexibility of the locking ring 71 allows backing ring 61 to more readily move with the deflection of the journal 12, yet, still allow locking ring 71 to restrain the axial displacement of backing ring 61.

Referring now to FIG. 3, second embodiment of the backing ring assembly of the present invention is shown. Components with identical reference numerals to FIGS. 1 and 2 will not be described.

Referring now to FIG. 3, a second embodiment of the backing ring assembly is shown. Backing ring 161 is shown as a generally cylindrical, ring shape structure having a laterally outward face 165 that comprises a cutout section, into which the lateral inward edge 125 of wear ring 24 is fit. Backing ring 161 further comprises a laterally inwardly curved face 166 which is adjacent fillet 116 of axle shaft 14. Locking ring 171 is seen as a cylindrical ring shaped structure having a laterally inner end 174 and a laterally outer end 172. Laterally outer end 172 includes a projection 176 that is received into a corresponding radial outwardly facing cutout section of backing ring 161. Laterally inward end 174 of locking ring 171 is seen to include an inner radially facing 176 surface that is adjacent axle cylindrical surface 119. Laterally outward end 172 of locking ring 171 is seen to have an radially inward facing section 175 which is adjacent a radially outward facing section 163 of backing ring 161. Backing ring 161 and locking ring 171 are typically comprised of steel.

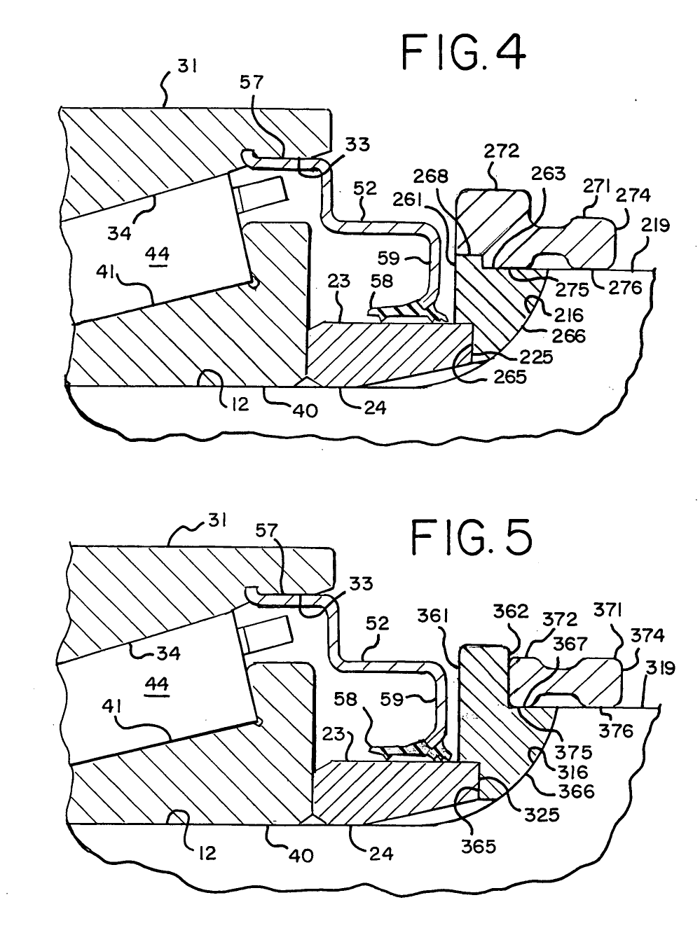

Referring now to FIG. 4, a third embodiment of the backing ring assembly of the present invention is shown. Components with identical reference numerals to FIGS. 1 and 2 will not be described.

Backing ring 261 is shown as a generally cylindrical, ring shape structure having a laterally outward face 265 that comprises a cutout section, into which the radial inward edge 225 of wear ring 24 is fit. Backing ring 261 further comprises a laterally inward curved face 266 which is adjacent fillet 216 of axle shaft 14. Locking ring 271 includes an radially inward facing section 274 that includes an inner radial facing surface 276 that is adjacent axle cylindrical surface 219. Locking ring 271 also includes a lateral outward end 272 that itself includes a cutout section at the lateral outward facing end thereof. Backing ring 261 includes a radially outward projecting portion 268 which extends into cutout section of locking ring 271. Locking ring outer end 272 includes an inner radial surface 275 that is adjacent radial outer surface 263 of backing ring 261. Backing ring 261 and locking ring 271 are typically comprised of steel.

Referring now to FIG. 5, a fourth embodiment of the backing ring assembly of the present invention is set forth. Components with identical reference numerals to FIGS. 1 and 2 will not be describe.

Backing ring 361 is shown as a generally cylindrical, ring shape structure having a laterally outward face 365 that comprises a cutout section, into which the lateral inward edge 325 of wear ring 24 is fit. Backing ring 361 further comprises a laterally inward curved face 366 which is adjacent fillet 316 of axle shaft 14. Locking ring 371 is seen as a cylindrical ring shape structure having a laterally inward end 374 and a laterally outer end 372. Laterally outer end 372 includes a lateral flat surface that is received against a corresponding radial inward facing cutout section of backing ring 361. Laterally inward end 374 of locking ring 371 is seen to have a radially inner surface 376 adjacent axle cylindrical surface 319. Laterally outward end 372 of locking ring 371 is seen to have an radially inward facing section 375 which is adjacent a radially outward facing section 367 of backing ring 361. Backing ring 361 is seen to include an extended radial section 362 which extends radially beyond the outer radial edge of locking ring 371. Backing ring 361 and locking ring 371 are typically comprised of steel.

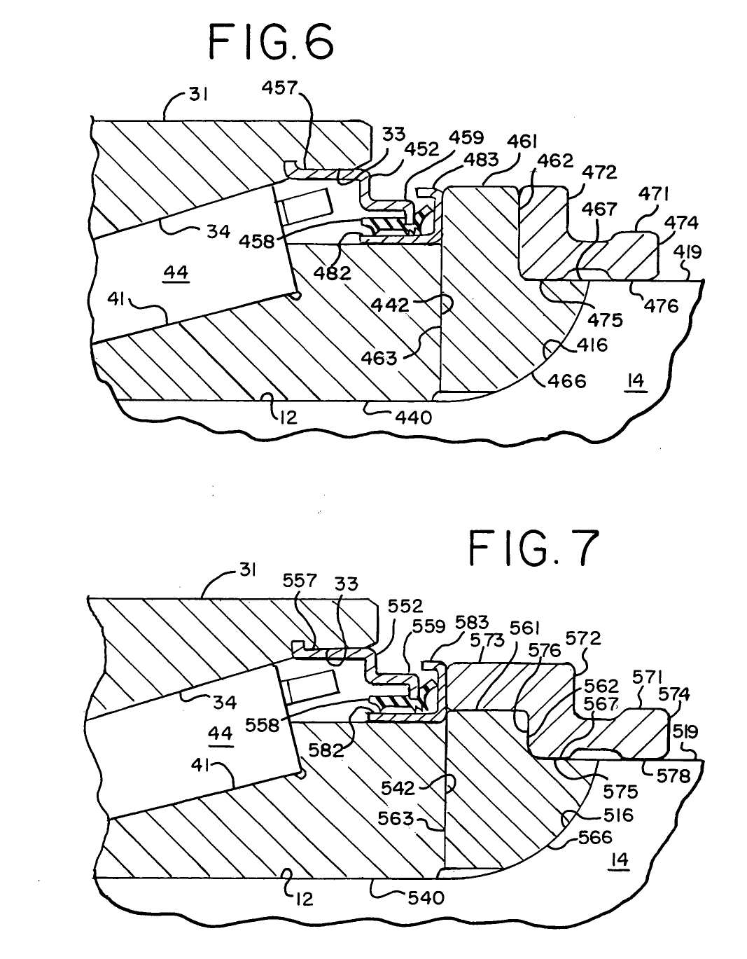

Referring now to FIG. 6, a fifth embodiment of the present invention is shown. Components with identical reference numerals to FIGS. 1 and 2 will not be described.

Bearing seal 452, which is generally cylindrical ring shaped structure, is seen to have an outwardly facing lateral end 457 which is received in an inner facing engagement with radially inner surface 33 of bearing cup 31. Radially inner facing end 459 of bearing seal 452 is seen to include a resilient member 458. Bearing seal seat 482 is seen to be a generally cylindrical, ring shaped structure having an radially inner facing base received on radially outer facing surface of bearing cone 440. Bearing seal seat 482 is also seen to have a radially outward extending end 483 which includes a portion adjacent a laterally outward facing wall 463 of backing ring 461.

Laterally outward facing wall 463 of backing ring 461 is seen to be adjacent laterally inner facing wall 442 of bearing cone 440. Backing ring 461 is seen to have a curved section 466 which is adjacent fillet section 416 of axle 14. Locking ring 471 is seen to comprise a generally cylindrical ring shaped structure having an laterally inward facing end 474 and a laterally outer facing end 472. Laterally outer facing end 472 of locking ring 471 is seen to extend radially outward further than laterally inward facing end 474. Further, laterally outward facing end 472 is seen to be adjacent a laterally inward facing wall 462 of backing ring 461. Further, laterally outward section 472 is also seen to have a radially inward surface 475 which is adjacent radially outward facing surface 467 of backing ring 461. Radially inward facing surface 476 of laterally inward facing end 474 is seen to be adjacent the cylindrical surface 419 of axle 14. Backing ring 461 and locking ring 471 are typically comprised of steel.

Referring now to FIG. 7, a sixth embodiment of the backing ring assembly of the present invention is shown. Components with identical reference numerals to FIGS. 1 and 2 will not be described.

Bearing seal 552, which is generally cylindrical ring shaped structure, is seen to have an outwardly facing lateral end 557 which is received in an inner facing engagement with radially inner surface 33 of bearing cup 31. Radially inner facing end 559 of bearing seal 552 is seen to include a resilient member 558. Bearing seal seat 582 is seen to be a generally cylindrical, ring shaped structure having an radially inner facing base received on radially outer facing surface of bearing cone 540. Bearing seal seat 582 is also seen to have a radially outward extending end 583 which includes a portion adjacent an laterally outward facing wall 563 of backing ring 561.

Backing ring 561 is seen to comprise a generally cylindrical ring shaped structure wall having a laterally outward facing wall 563 that is adjacent laterally inward facing wall 542 of bearing cone 540. Backing ring 561 is also seen to comprise a curved section 566 which is adjacent curved fillet 516 of axle 14. Backing ring 561 is also seen to comprise a radially extending section 562 that extends beyond the radial extent of cylindrical surface 519 of axle 14.

Locking ring 571 is seen to comprise a laterally inward facing section 574. Laterally inward section 574 includes a radially inward section 578 that is adjacent cylindrical surface 519 of axle 14. Locking ring 571 is also seen to include a laterally outward extending section 572 that includes laterally outward end 573 that is adjacent bearing seal seat 583. Further, raised radially extending section 562 of backing ring 561 is seen to be received in a complementary section 576 of locking ring 571. Locking ring 571 is also seen to comprise a laterally centrally located inwardly radially facing section 575 that is adjacent radially outer facing surface 567 of backing ring 561. Backing ring 561 and locking ring 571 are typically comprised of steel.

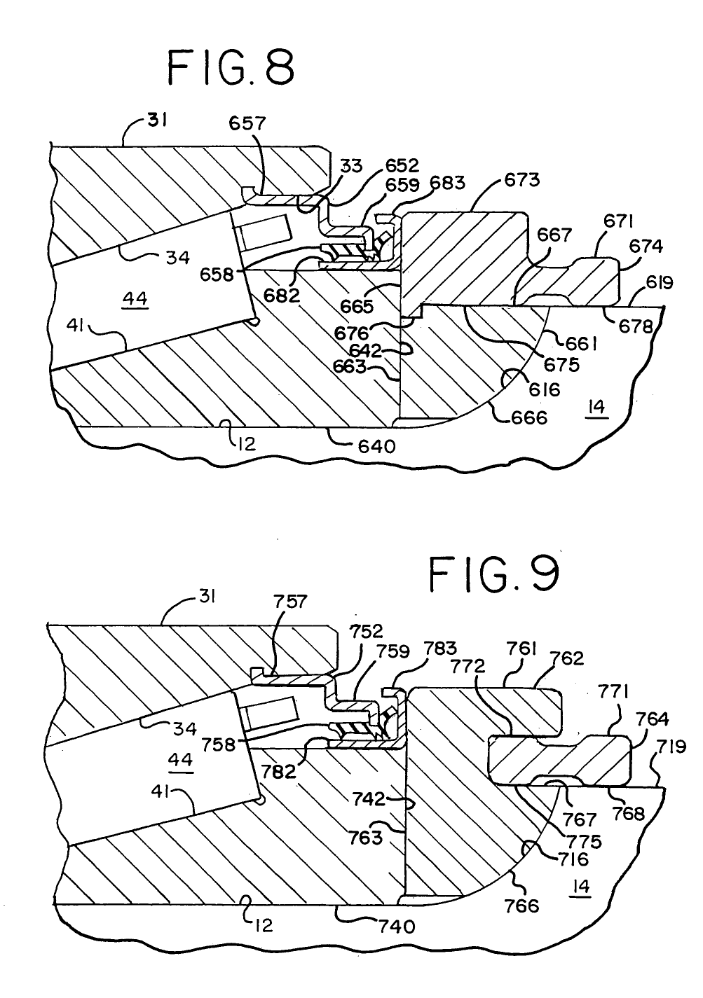

Referring now to FIG. 8, a seventh embodiment of the present invention is shown. Bearing seal 652, which is generally cylindrical ring shaped structure, is seen to have an outwardly facing lateral end 657 which is received in facing engagement with radially inner surface 33 of bearing cup 31. Radially inner facing end 659 of bearing seal 652 is seen to include a resilient member 658. Bearing seal seat 682 is seen to be a generally cylindrical, ring shaped structure having an radially inner facing base received on radially outer facing surface of bearing cone 640. Bearing seal seat 682 is also seen to have a radially outward extending end 683 which includes a portion adjacent a laterally outward facing wall 665 of locking ring 671. Laterally facing outer wall 665 of locking ring 671 also has a portion adjacent generally flat surface 642 of bearing cone 640.

Backing ring 661 is seen to comprise a generally cylindrical, ring shaped structure having an laterally outer facing flat surface 663 which is adjacent a laterally inward facing generally flat surface 642 of bearing cone 640. Backing ring 661 also is seen to comprise a curved surface 666 which is adjacent fillet 616 of axle 14. Backing ring 661 also includes a radially outer facing surface 667 which is adjacent a complementary radially inner facing surface 675 of locking ring 671.

Locking ring 671 is seen to comprise a laterally inner end 674. Laterally inner end 674 is seen to comprise a radially inner facing surface 678 which is adjacent cylindrical surface 619 of axle 14. Locking ring 671 is also seen to comprise a laterally outer end 673 which includes a laterally outer flat surface 665 which is adjacent bearing seal seat 683. Locking ring 671 also is seen to comprise a radially inner facing protrusion 676 which is received in a complementary cutout section in the radially outer facing surface 667 of backing ring 661. Backing ring 661 and locking ring 671 are typically comprised of steel.

Referring now to FIG. 9, an eighth embodiment of the backing ring assembly of the present invention is shown. Components with identical reference numerals to FIGS. 1 and 2 will not be described.

Bearing seal 752, which is generally cylindrical ring shaped structure, is seen to have an outwardly facing lateral end 757 which is received in an inner facing engagement with radially inner surface 33 of bearing cup 31. Radially inner facing end 759 of bearing seal 752 is seen to include a resilient member 758. Bearing seal seat 782 is seen to be a generally cylindrical, ring shaped structure having an radially inner facing base received on radially outer facing surface of bearing cone 740. Bearing seal seat 782 is also seen to have a radially outward extending end 783 which includes a portion adjacent a laterally outward facing wall 763 of backing ring 761.

Backing ring 761 is seen to comprise a generally cylindrical, ring structure. Backing ring 761 includes a laterally outwardly facing flat face 763 which is adjacent laterally inward facing flat face 742 of bearing cone 740. Backing ring 761 also includes a curved generally inwardly facing surface 766 which is adjacent complementary generally curved fillet 716 of axle 14. Backing ring 761 is also seen to include a radially outward edge 762 which forms, with radial surface 767, a cutout section of backing ring 761.

Locking ring 771 is seen to comprise a generally cylindrical ring like structure having laterally inward end 764. Laterally inward end 764 is seen to have a surface 768 engaging cylindrical surface 719 of axle 14. Locking ring 771 is also seen to comprise a laterally outward end 772 which includes a radially inward edge 775 which engages radial surface 767 of backing ring 761. Backing ring 761 and locking ring 771 are typically comprised of steel.

What is claimed is:

1. In combination, an axle having:
an end section of a first diameter, a journal at the axle end section,
a shoulder adjacent the journal,
and a second larger diameter axle section adjacent the shoulder,
a bearing assembly placed around the journal,
a bearing end cap affixed to the axle end section to secure the bearing assembly on the journal,
the bearing assembly comprising:
a backing ring adjacent the axle shoulder,
a backing ring having an inner lateral end of a first radial diameter and an outer lateral end of a second radial diameter,
wherein the outer lateral end of the locking ring engages the backing ring and the inner lateral end of the locking ring engages the second axle section.

2. The combination of claim 1
further comprising a wear ring,
the wear ring having an inner radial surface adjacent the journal, and an inner lateral edge,
the backing ring having an inner radial cutout section,
the inner radial edge of the wear ring received in the inner radial cutout section of the backing ring.

3. The combination of claim 1
further comprising
the backing ring having an outer radial edge,
the locking ring having an outer lateral cutout section,
the outer radial edge of the backing ring received in the outer lateral cutout section of the locking ring.

4. The combination of claim 1
further comprising
the locking ring outer lateral end including radially inward extending rim,
the backing ring including an outer radial cutout section,
the locking ring radially inward extending rim received in the backing ring outlet radial cutout section.

5. The combination of claim 1
further comprising
the locking ring outer lateral end includes an inner radial cutout section,
the backing ring includes a radially extending rim,
the backing ring radially extending ring received in the locking ring inner radial cutout section.

6. The combination of claim 1
further comprising
a generally cylindrical bearing cup,
a generally cylindrical first bearing seal having a first end received in the bearing cup,
and a second end having a resilient member affixed thereto,
and a second bearing seal adjacent a radial outer surface of the bearing cone and a lateral outer surface of the backing ring,
wherein the resilient member contacts the second bearing seal.

7. The combination of claim 1
further comprising
a radial inner extending edge of the backing ring forming a receiving opening in the backing ring,
and the locking ring extending into the receiving opening.

8. In combination,
an axle having:
an end section of a first diameter,
a journal at the axle end section,
a shoulder adjacent the journal,
and a second, larger diameter axle section adjacent the shoulder,
a bearing assembly placed around the journal,
a bearing end cap affixed to the axle end section to secure the bearing assembly on the journal,
the bearing assembly comprising:
a backing ring adjacent the axle shoulder,
a locking ring having an inner lateral end and an outer lateral end,
wherein the outer lateral end of the locking ring engages the backing ring
and the inner lateral end of the locking ring engages the second axle section.

9. The combination of claim 8
further comprising a wear ring,
the wear ring having an inner radial surface adjacent the journal,
and an inner lateral edge,
the backing ring having an inner radial cutout section,
the inner lateral edge of the wear ring received in the inner radial cutout section of the backing ring.

10. The combination of claim 8,
further comprising
the backing ring having an outer radial edge and forming an outer radial shelf section,
the outer lateral edge of the locking ring received on the outer radial shelf section of the backing ring.

11. In combination,
an axle having:
an end section of a first diameter,
a journal at the axle end section,
a shoulder adjacent the journal,
and a second larger diameter axle section adjacent the shoulder,
a bearing assembly placed around the journal,
a bearing end cap affixed to the axle end section to secure the bearing assembly on the journal,
the bearing assembly comprising:
a backing ring adjacent the axle shoulder,
a locking ring having an inner lateral end and an outer lateral end,
wherein the outer lateral end of the locking ring engages the backing ring and the inner lateral end of the locking ring engages the second axle section,
and further comprising a wear ring,
the wear ring having an inner radial surface adjacent the journal,
and an inner lateral edge,
the backing ring having an inner radial cutout section,
the inner lateral edge of the wear ring received in the inner radial cutout section of the backing ring.

12. The combination of claim 11
further comprising
the backing ring having an outer radial edge,
the locking ring having an outer lateral cutout section,
the outer radial edge of the backing ring received in the outer lateral cutout section of the locking ring.

13. The combination of claim 11
further comprising
the locking ring outer lateral end forming a radially inward extending rim,
the backing ring including an outer radial cutout section,
the locking ring radially inward extending rim received in the backing ring outer radial cutout section.

14. The combination of claim 11
further comprising
the locking ring outer lateral end includes an inner radial cutout section,
the backing ring includes a radially extending rim,
the backing ring radially extending ring received in the locking ring inner radial cutout section.

15. The combination of claim 11
further comprising
a generally cylindrical bearing cup,
a generally cylindrical first bearing seal having a first end received in the bearing cup,
and a second end having a resilient member affixed thereto,
and a second bearing seal adjacent a radial outer surface of the bearing cone and a lateral outer surface of the backing ring,
wherein the resilient member contacts the second bearing seal.

16. The combination of claim 11
further comprising
a radial inner extending edge of the backing ring forming a receiving opening in the backing ring,
and the locking ring extending into the receiving opening.
